(19) United States
(12) Patent Application Publication
(10) Pub. No.: US 2013/0239603 A1
(43) Pub. Date: Sep. 19, 2013

(54) HEAT PUMP WITH INDEPENDENT SUBCOOLER CIRCUIT

(71) Applicant: Luther D. Albertson, Sellersburg, IN (US)

(72) Inventor: Luther D. Albertson, Sellersburg, IN (US)

(21) Appl. No.: 13/420,766

(22) Filed: Mar. 15, 2012

(51) Int. Cl. F25B 29/00; B23P 15/26

(52) U.S. Cl. 62/238.6; 29/890.035

(57) ABSTRACT

An improved reversible cycle heat pump system incorporating powered subcooling to increase heating capacity by over 50 percent over conventional heat pump technology without imposing a performance penalty; wherein over 21 percent is attributable to evaporator capacity gained by subcooling, over 21 percent is attributable to recovery and utilization of sensible heat energy removed as a by-product of subcooling, and over 8 percent is attributable to recovery and utilization of sensible heat energy resulting from the conversion of electric energy to mechanical work, heat of compression, and mechanical heat of friction. The powered subcooling improvement is also easily installed as original equipment, or retrofitted to existing heat pump systems.

### BACKGROUND OF THE INVENTION

Air-source heat pumps are the dominant heating source in the southern United States and in many places around the globe. They typically yield minimum vapor cycle efficiencies in excess of 200 percent and offer savings in operating expense over fossil fuel and direct electric heating systems. However, generally speaking heat pumps have been ignored in cold climates because their performance envelopes are limited to an ideal range, and falling outside that range on the heating side leads to high operating costs and discomfort in the conditioned space, i.e. home.

In the southern parts of the United States, air-source heat pumps are known for their low operating costs. However, moving northward their advantage abates, and fossil fuel becomes more prevalent as a heating source. This is unfortunate for consumers. According to the U.S. Department of Energy's Energy Information Administration (EIA), over the past decade fossil fuel prices have increased an average of about 12 percent annually. Electricity, on the other hand, has been more stable, increasing less than 3 percent annually on average over the same time period making electricity an inviting energy source.

Heat pumps in northern climates suffer a number of limitations stemming from the fact that they are designed primarily for air-conditioning applications. As climates become cooler and heating becomes more of the primary HVAC function conventional air-source heat pumps lose heating capacity and are unable to satisfy the heat load requirement of the conditioned space. The need to utilize electric resistance heat, i.e. strip heaters, or fossil fuels to supplement the heat pump often makes these systems expensive to operate. As it gets colder outside the delivery air temperature inside declines when supplemental heat is not being used. Supply air temperatures that are warmer than the return air temperatures add heat to the conditioned space, but can feel uncomfortable when these temperatures drop below body temperature.

High electric use, discomfort, and operating expenses are not only undesirable for the consumer, but for electric utilities as well. As utilities constantly seek ways to balance loads, reduce seasonal peaking, and generate more revenue to pursue more efficient means of generation, a conflict is created when a conventional heat pump system relies on resistance heat. The high electric usage in the heating season drives up winter demand and can make heat pumps an unattractive technology in colder climates.

The fact that heating capacity of air-source heat pumps is marginal in climates much below 40 degrees Fahrenheit outdoor ambient temperature is well known in the HVAC industry; moreover, that heating capacity degrades precipitously with declining outdoor ambient temperature. The reason for this shortfall has to do with the correlation between specific volume of vapor and mass flow of refrigerant in conjunction with the correlation between temperature of refrigerant condensate entering the expansion valve and prevailing evaporating temperature.

The capacity of a vapor compression cycle refrigeration machine, regardless of type or purpose, is a direct function of the mass flow (lbs/min) of refrigerant circulated through the system by the compressor. The compressor is simply a fixed volume mechanical pumping device whose sole function is to pump refrigerant vapor from the evaporator to the condenser at a predetermined volumetric rate (cfm), wherein, system capacity (Btu/hr) is a function of the mass flow (Lbs/min) of refrigerant circulated through the system, thus, mass flow is dependant entirely upon the specific volume of the vapor inducted by the compressor and any change in vapor temperature has a direct impact on mass flow. Because specific volume of vapor is a function of its temperature its volume changes with changing temperature, that is, the specific volume of vapor, i.e. cubic feet per pound, increases (density decreases) with decreasing temperature and visa versa. Albeit this phenomenon is characteristic of vapor compression cycle refrigeration in general it has its greatest negative impact on the capacity of air-source heat pumps operating in the heating mode because that is when the evaporator is subjected to the widest range of outdoor ambient temperatures from cool to extreme cold. Thus, declining outside ambient temperature is one contributing cause of the fore mentioned shortfall.

A second related cause of the shortfall is the generation of non-productive high specific volume vapor in the evaporator exacerbated by declining outdoor ambient temperature. After the refrigerant vapor is fully condensed and liquefied in the condenser considerable heat energy remains in the warm condensate. This residual heat energy causes a portion of the liquid to self-evaporate during the pressure reduction process, as it throttles from the expansion valve into the evaporator, creating a substantial volume of non-productive high specific volume vapor in the process.

In the vapor compression refrigeration cycle the quantity of heat that each pound of refrigerant absorbs while flowing through the evaporator is known as the refrigeration effect. Each pound flowing through the evaporator is able to absorb only the heat required to vaporize it plus any additional superheating that may occur. If the liquid entering the expansion valve were at the same temperature at which it was vaporizing in the evaporator the heat that the refrigerant could absorb would be equal to its heat of vaporization, wherein, the total volume of vapor generated would be productive (heat producing) vapor, wherein, evaporator refrigeration effect would be identical to the heat of vaporization, or 100 percent efficient. However, the temperature of the liquid refrigerant entering the expansion valve is always at a substantially higher temperature than evaporating temperature and never less than conditioned air temperature, thus refrigeration effect is always less than the heat of vaporization and therefore always less than 100 percent efficient. To make matters worse, the greater the differential between the temperature of the liquid condensate approaching the expansion valve and evaporating temperature the greater the quantity of liquid consumed during the pressure reduction process and thus the greater the volume of non-productive high specific volume vapor generated for the compressor to induct.

Obviously, that portion of the liquid already evaporated during the pressure reduction process is liquid that is no longer available to absorb heat energy from the outdoor ambient air. Nevertheless, the resulting non-productive vapor must still pass through the system evaporator creating additional pressure drop and ultimately inducted and compressed to condensing level by the compressor. Since the compressor is a fixed volume pumping device any non-productive vapor inducted reduces the volume of productive vapor inducted and compressed and ultimately capacity. Therefore, another factor contributing to the fore mentioned shortfall is generation of large quantities of non-productive high specific volume vapor in the evaporator that can easily reduce capacity 20 percent or more. The only way to reduce or prevent formation of non-productive vapor in the evaporator is to minimize the temperature difference between the liquid entering the expansion valve and evaporating temperature, and this can only be accomplished by subcooling the liquid condensate before entering the expansion valve.

Subcooling is a term used to describe the cooling of a liquid refrigerant at constant pressure to a point below the temperature at which it was condensed, i.e. at 331.24 psia, refrigerant R-410A vapor condenses at a temperature of 100 degrees Fahrenheit. If, after the vapor has been completely condensed, the liquid is cooled still further to a temperature of 78 degrees Fahrenheit, it will have been subcooled 22 degrees.

In the theoretical refrigeration cycle heat is added to the refrigerant liquid only as it passes through the evaporator, wherein liquid refrigerant flowing through the expansion valve neither gains nor loses heat energy. Heat energy added to each pound of refrigerant in the evaporator is the difference between the enthalpy of the vapor leaving the evaporator and the enthalpy of the liquid-vapor mixture entering the evaporator wherein no heat energy is added to the refrigerant during the throttling process. Therefore, the heat energy added in the evaporator must always equal the difference between the enthalpy of the liquid entering the expansion valve and the enthalpy of the vapor leaving the evaporator.

As an illustration of how subcooling increases heat pump heat capacity consider a typical 3-ton air-source heat pump utilizing refrigerant R-410A operating in heating mode at 35 degrees Fahrenheit outdoor ambient temperature; Refer to FIG. 1 chart “Thermodynamic Properties of DuPont Suva™ 410A Refrigerant” and to FIG. 2 “Expanded Heating Data” for the Goodman Manufacturing model SSZ140361B 3-ton (36.0 Mbh) air-source heat pump. First notice, as a point of reference, that the nominal 36.0 Mbh (36,000 Btu) rating for this model occurs at about 55 degrees Fahrenheit outdoor ambient air temperature.

Referring to FIG. 1 we find the enthalpy of vapor at 35 degrees Fahrenheit is 121.3 Btu/lb. Assume the temperature of the liquid condensate leaving the condenser (indoor coil) and entering the expansion valve at the evaporator (outdoor coil) is 75 degrees Fahrenheit (typical for 35 degrees Fahrenheit ambient) with an enthalpy of 41.9 Btu/lb. Thus, 121.3 Btu/lb−41.9 Btu/lb=79.4 Btu/lb net refrigeration effect. Next, from FIG. 1 we find the density of vapor at 35 degrees Fahrenheit is 2.0183 pounds per cubic foot, multiplying that times 0.9504 cfm/ton (typical compressor pumping capacity)=1.9182 lbs/min circulated. Thus, 1.9182 lbs/min×79.4 Btu/lb=152.3 Btu/min×60 min=9,138 hr×3 (3 ton system)=27,414 Btu/hr refrigeration capacity at 35 degrees Fahrenheit outdoor air temperature. Notice that this correlates with the 27.4 Mbh capacity of the fore mentioned Goodman 3-ton unit at 35 degrees Fahrenheit outdoor ambient temperature.

Now consider the same heat pump wherein the liquid is subcooled from 75 degrees Fahrenheit to 32 degrees Fahrenheit. Enthalpy of liquid at 32 degrees Fahrenheit is 25.3 Btu/lb, thus, 121.3 Btu/lb−25.3 Btu/lb=96.0 Btu/lb (a gain of 16.6 Btu/lb) refrigeration effect. Therefore, circulating 1.9182 lbs/min×96.0 Btu/lb=184.1472 Btu/min×60 min=11,048.832 Btu/hr×3 (3 tons)=33,146 Btu/hr refrigeration effect. Thus, 33,146 Btu/hr-27,414 Btu/hr=5,732 Btu/hr net capacity increase. Dividing 5,732 Btu/hr by 27,414 Btu/hr equals a 20.9 percent increase in capacity. In this example the refrigerant is subcooled 3 degrees cooler than the evaporator at 35 degrees Fahrenheit outdoor temperature. Since the powered subcooler operates at a preset evaporating temperature, i.e. 32 degrees Fahrenheit, it can, at times, be 30 degrees Fahrenheit or more lower than prevailing evaporating temperature. However, an additional refrigeration effect, resulting from the lower liquid temperature, is obtained without a corresponding increase in energy consumption. Conclusion; subcooling can yield a worthwhile increase in both heating efficiency and capacity.

Although the enthalpy of a refrigerant does not change as it passes through the expansion valve, there is however a change in the refrigerant itself, that is, a quantity is vaporized. This change is due to the fact that no substance can remain a liquid at a temperature higher than boiling temperature corresponding to its pressure. Thus, in the first example, without subcooling, the heat that each pound of liquid surrenders when cooling from 75 degrees Fahrenheit to 35 degrees Fahrenheit is the difference in enthalpy of liquid at 75 degrees Fahrenheit and 35 degrees Fahrenheit, or 41.9 Btu/lb−26.4 Btu/lb=15.5 Btu/lb. Since the latent heat required to vaporize 1.0 lb of liquid at 35 degrees Fahrenheit is 121.3 Btu/lb but only 15.5 Btu/lb are available the weight of liquid vaporized is 15.5 Btu/lb divided by 121.3 Btu/lb=0.127 Btu/lb. In other words, of each pound of refrigerant leaving the expansion valve flowing into the evaporator 0.127 lb will be vapor and 0.873 lb will be liquid. Thus, 12.7 percent of the liquid was vaporized passing through the expansion valve, wherein only vaporization of the remaining 87.3 percent of the liquid is useful in producing the refrigeration effect. In other words, 12.7 percent of the vapor the compressor is required to pump is non-productive. At extreme cold outdoor conditions that percentage can exceed 50 percent.

As previously stated, that portion of the liquid already evaporated during the pressure reduction process is liquid that is no longer available to absorb heat energy from the ambient air. Nevertheless, the resulting non-productive high specific volume vapor must still pass through the system evaporator creating additional pressure drop and ultimately inducted and compressed to condensing level by the compressor. Thus, one objective of the invention is to minimize formation of non-productive vapor in the evaporator. The only way this can be accomplished is by subcooling the liquid condensate to as near evaporating temperature as possible prior to entering the expansion valve.

Basically there are four methods of subcooling liquid condensate, the most common of which is simply dimensioning the condensing coils to incorporate a dedicated ambient air or water cooled subcooling section. Another commonly used method is incorporation of an internal liquid to suction heat exchanger wherein subcooling is achieved by transferring heat energy from the warmer liquid condensate to the cooler suction vapor. However, the benefit of internal heat exchangers is limited and even questionable from an energetic point of view. Still another method, wherein limited subcooling can be provided, is by installing the receiver or piping, respectively, outdoors, thus allowing for seasonal dependant subcooling. All the above methods are applicable exclusively to refrigeration and air conditioning systems, and the cooling cycle of a heat pump system. Lastly, the most effective method of subcooling liquid condensate is utilization of an external heat exchanger wherein subcooling is achieved via a secondary cooling agent, i.e. water, brine or secondary dedicated mechanical refrigeration system called a powered subcooler operating at a lower temperature.

Powered subcoolers are typically used in low-temperature refrigeration systems, such as in supermarket refrigerators and freezers. They use a separate refrigeration circuit for cooling refrigerant liquid in the primary refrigeration system in order to obtain lower evaporator temperature as well as increase capacity. However, due to modest capacity gain and a relatively high performance penalty, powered subcooling has found little or no use in residential air conditioning and heat pump systems, and never in the heating cycle.

Powered subcooling systems commonly dispose of heat energy removed during the subcooling process by rejecting it into ambient air or other cooling medium outside the system. This is because subcooling is usually done within the context of refrigeration and air condition where saving excess heat is undesirable. However, for a heat pump operating in the heating mode, the objective is reversed making it advantageous to further increase heat capacity by preserving any extra heat energy generated by the system that would otherwise be wasted.

For example, in the process of subcooling liquid condensate from 75 degrees Fahrenheit to 32 degrees Fahrenheit about 5,732 Btu/hr of sensible heat is removed from the liquid condensate. Rather than rejecting this valuable heat energy to the ambient air where it is wasted, it is instead rejected into the conditioned air stream where it is utilized to boost heating capacity 5,732 Btu/hr for another 20.9 percent capacity increase without the heat pump having to produce one extra Btu, thus, the benefit of subcooling is doubled to 41.8 percent.

However, that's not all. It is well known in the HVAC industry that electrically powered devices, such as compressors, motors, etc, emit heat energy. In fact, 100 percent the electric energy consumed by all electrical devices is ultimately converted into heat. It is because of this fact that when such devices are located within the conditioned space or conditioned air stream this heat energy must be factored into cooling load calculation.

For example, a ½ hp hermetic compressor used in a powered subcooling circuit would have a power rating of 710 watts. Converting 710 watt/hrs into heat equals 2,422 Btu/hr of sensible heat energy. This heat energy, plus heat of friction, must be continuously removed to prevent overheating of the hermetic compressor motor. This could be easily accomplished by circulating cold saturated suction vapor from the evaporator over the hermetic motor and other internal mechanical parts, wherein most of the heat is absorbed by the cold vapor and rejected to the ambient air by the subcooler condenser along with latent heat of condensation. The balance of the heat is radiated through the steel compressor shell to the ambient air. On the other hand, a similar result could be more simply achieved by positioning the entire subcooling circuit including the ½ hp hermetic compressor, in the air stream where 100 percent of the 2,422 Btu/hr of heat energy could be recovered. Moreover, since heat out equal's power in, no performance penalty is imposed on the cost of the heat pump operation by the operation of the subcooler.

What is needed then, is an independent subcooler unit that can be easily installed with new heat pump systems, or added to existing systems, that increases the efficiency of the heat pump system by subcooling the refrigerant leaving the condenser before it enters the evaporator, that also captures the heat energy dissipated and generated by the subcooling process itself.

### SUMMARY OF THE INVENTION

The heat pump system described herein addresses the problem of increasing heat pump efficiency, particularly in colder climates. It solves this problem by attaching an independent secondary refrigeration circuit, also operating in the heating mode, to the primary heat pump refrigeration circuit. This secondary, or subcooling, circuit operates as described above to reduce the temperature of the refrigerant fluid entering the primary evaporator. The warm liquid refrigerant is passed through a heat exchanger coupled to the secondary refrigeration circuit so that heat from the primary refrigerant passes to the secondary refrigerant. The heat in the secondary refrigerant is then also dissipated in the enclosed space along with heat generated by the compressor and other machinery of the secondary refrigeration circuit. This allows not only an increased efficiency in the primary refrigeration circuit, but also allows heat extracted from primary refrigerant by the subcooler to be captured and used to heat the enclosed space rather than be lost further increasing the overall efficiency of the system.

It is also described herein a method of retrofitting existing heat pump systems with an independent subcooling system so that the benefits of having such a system are not limited solely to those installing new heat pump systems.

### BRIEF DESCRIPTION OF DRAWINGS

FIG. 1: Thermodynamic Properties of prior art DuPont Suva® 410A Refrigerant.

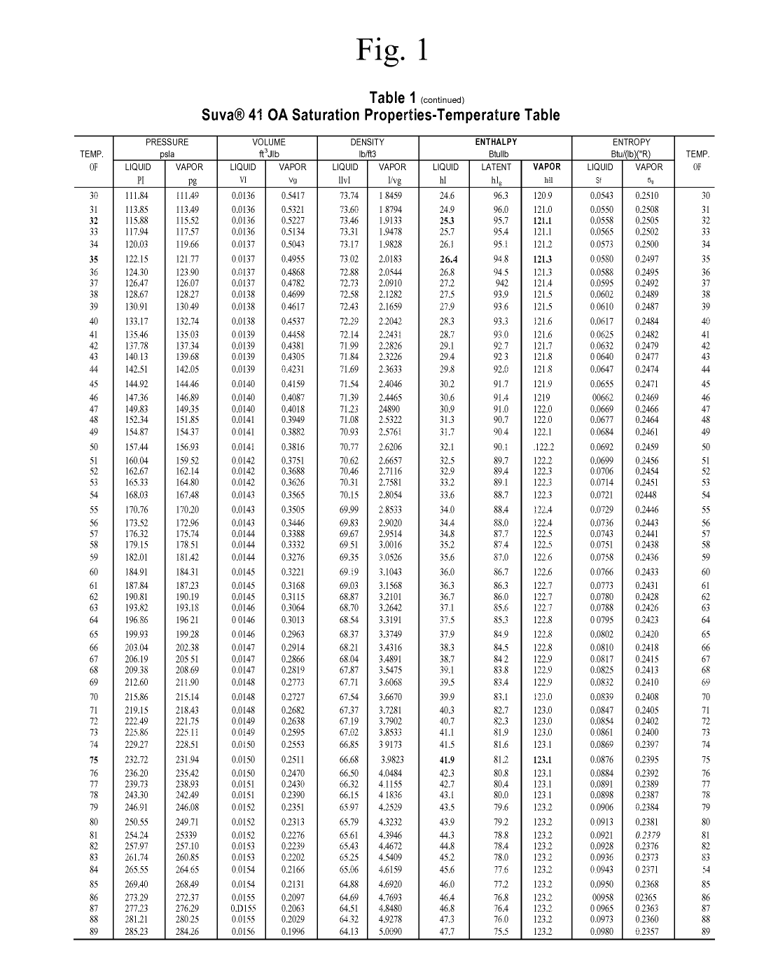

FIG. 2: Prior art Goodman manufacturing heat pump “Expanded Heating Data” chart.

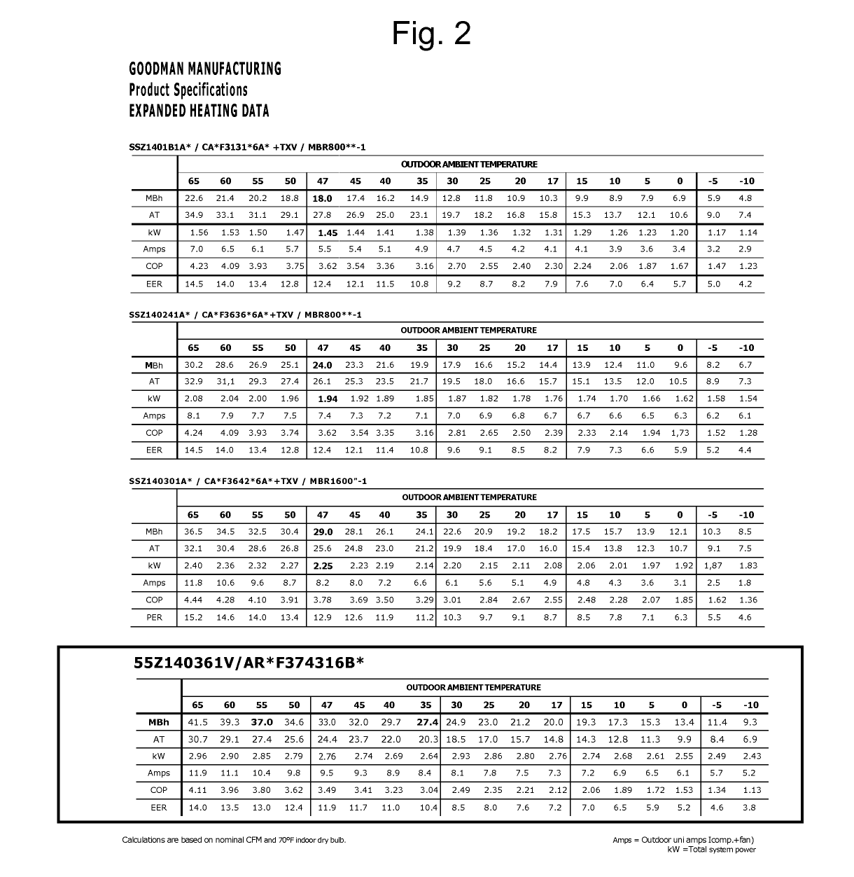

FIG. 3: Detailed view of prior art heat pump system shown in the heating mode without an independent subcooler circuit.

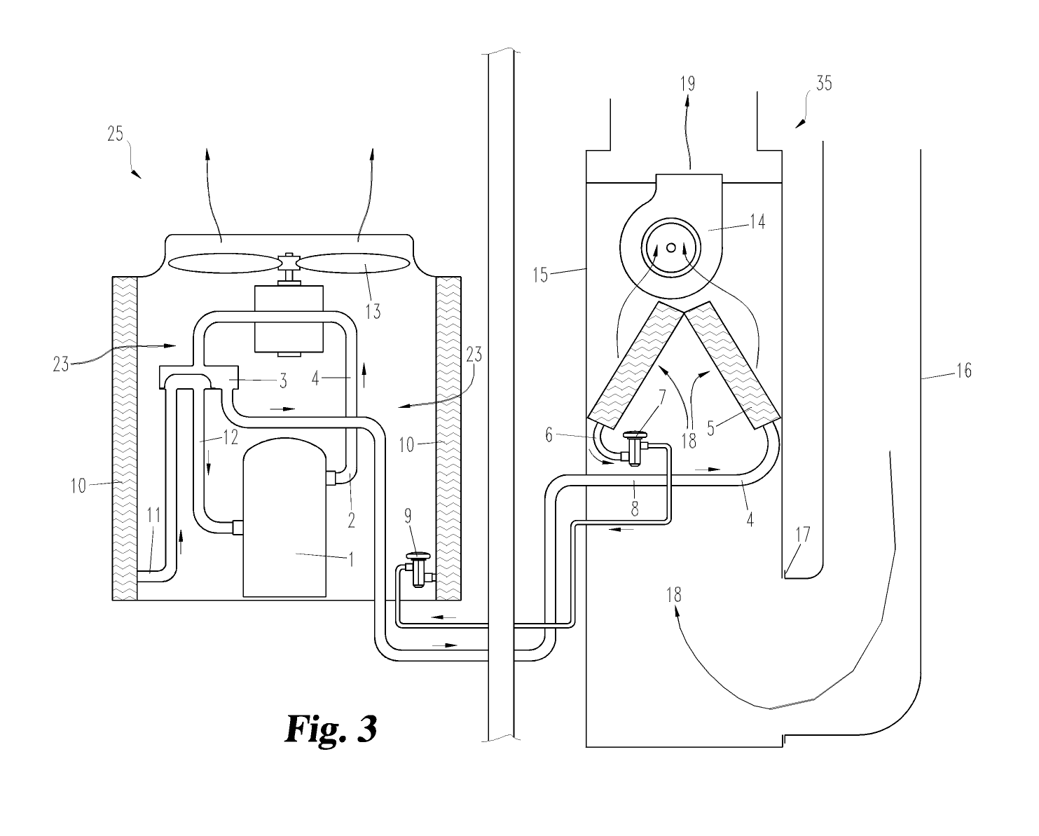

FIG. 4: Detailed view of applicant's heat pump system shown in the heating mode with an independent subcooler circuit installed.

FIG. 5: Detailed view of the heat pump system like that of FIG. 4 shown in the heating mode except with an independent subcooler circuit installed in an alternate location.

FIG. 6: Detailed view of the subcooler circuit of FIG. 5 installed in an alternate location.

### DETAILED DESCRIPTION OF THE INVENTION

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiment, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

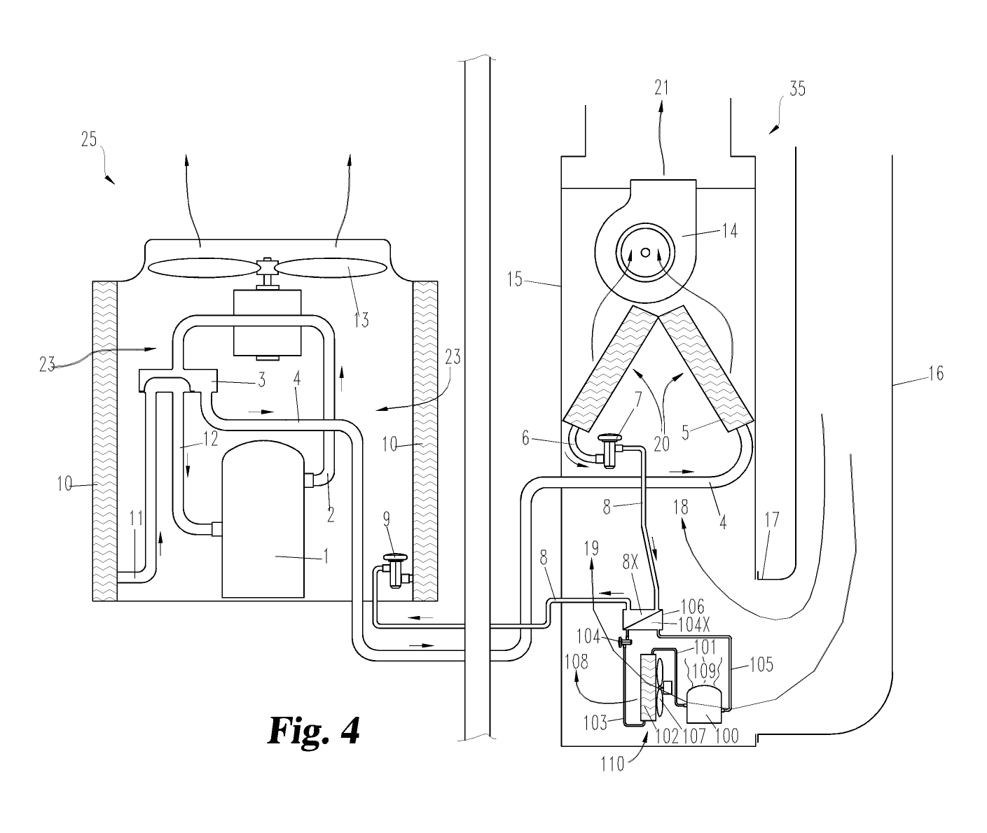

FIG. 4 illustrates one embodiment of an independent subcooler refrigeration circuit configured to work in conjunction with a primary refrigeration circuit operating in the heating mode. The primary circuit consists of outdoor section 25 and an indoor section 35 situated inside the enclosed space to be heated. Outdoor section 25 comprises compressor 1, evaporator fan 13, 4-way reversing valve 3, expansion device 9, and evaporator coil 10. Indoor section 35 has an air handler enclosure 15 serving as an air duct that contains a condenser coil 5, expansion device 7, blower 14, and a secondary refrigeration circuit 110. Secondary circuit 110 has a secondary compressor 100, secondary condenser 102, secondary condenser fan 107, secondary expansion device 104, and evaporator heat exchanger 106. The primary refrigeration circuit of sections 25 and 35 preferably uses a higher pressure refrigerant, such as chlorodifluoromethane (CHC1F2) commonly referred to by the American Society of Heating, Refrigerating and Air-conditioning Engineers (ASHRAE) as R-22, or mixtures of difluoromethane (CH2F2) and pentafluoroethane (CHF2CF3) commonly referred to by the ASHRAE designation R-410A. These refrigerants have working pressures between 50 and 105 psig at 0 degrees C. (where psig denotes the pounds per square inch of pressure measured at the gauge). The secondary circuit preferably uses a lower pressure refrigerant, such as tetrafluoroethane (CH2FCF3) commonly referred to by the ASHRAE designation R-134A which has a working pressure of around 25 psig at 0 degrees centigrade.

The various components of the primary and secondary refrigerant circuits can be any suitable to achieve the desired results. Primary compressor 1 and secondary compressor 100 are typically of the reciprocating type; however, they can be of the rotary or scroll type as manufactured by Copeland, Tecumseh, Danfoss and other compressor manufacturers. Expansion devices 7 and 9 are of the heat pump expansion valve type, such as the Sporlan Type RC expansion valve that incorporates an internal check valve allowing reverse refrigerant flow, thus eliminating the need for an external check valve. Other types of expansion valves or devices and/or check valve arrangements can be used. Heat exchanger 106 is typically of the coaxial “tube-in-tube” type, such as a Packless model COAX-2076-H, wherein, primary and secondary circuit refrigerants flow in a heat exchange relationship in the annulus between the inner and outer tubes. Other type heat exchangers, such as a plate type, can be utilized. Expansion device 104 is typically a constant pressure expansion valve such as the Parker Hannifin A-Series TEV, although other types of expansion valves or devices can be used. These examples are meant as illustrative rather than limiting as numerous types of valves, compressors, heat exchangers, and the like known to one of ordinary skill in the art can be arranged to achieve the desired end.

As the primary refrigeration circuit moves heat into the enclosed space, discharge conduits 2 and 4 supply pressurized heat laden refrigerant vapor to condenser coil 5, wherein, latent heat of condensation is surrendered to the cooler pre-conditioned air 18 circulated by blower 14. The resulting warm saturated liquid condensate flows from condenser 5, through conduit 6, and through the internal check valve of expansion valve 7. The warm fluid continues through conduit 8 and exchange side 8X of heat exchanger 106 which operates as the evaporator for the subcooler refrigeration circuit resulting in a heat exchange relationship with the cold subcooler refrigerant flowing through heat exchange side 104X of heat exchanger 106 thereby subcooling the primary refrigerant liquid condensate to approximately 32 degrees Fahrenheit. (Other temperatures are possible, and are anticipated, as would be understood by a person of ordinary skill in the art.) The now much cooler primary refrigerant flows through conduit 8 and expansion valve 9 into evaporator coil 10. As the now subcooled primary refrigerant liquid enters the low pressure evaporator 10 it absorbs latent heat of vaporization from outside ambient air 23 flashing into saturated vapor and is inducted by primary circuit compressor 1 via conduits 11 and 12 and 4-way reversing valve 3 to begin another cycle. As a result of subcooling the liquid entering evaporator 10 to approximately 32 degrees Fahrenheit evaporator refrigeration effect, and thus capacity is increase about 20.9 percent.

The heat energy removed from the primary circuit refrigerant as it passes through heat exchange side 8X of heat exchanger 106 is absorbed as latent heat of vaporization by the secondary refrigerant as it passes through heat exchange side 104X of heat exchanger 106, wherein the resulting saturated vapor is inducted by secondary compressor 100 and compressed into high pressure high temperature vapor in condenser 102, wherein the latent heat of condensation, motor heat and heat of friction is surrendered as sensible heat 108 to the cooler, pre-conditioned air 18 that has yet to be heated. Pre-condition air 18 is circulated by blower 14 and passes over subcooler circuit 110 causing radiated heat energy 109 to be absorbed by pre-conditioned air 18 creating partially heat conditioned air 19. Sensible heat 108, partially heat conditioned air 19, and other pre-conditioned air 18 mixes together to become heat laden partially conditioned air 20 and is drawn through condenser 5 by blower 14. Latent heat of condensation is then absorbed from the hot refrigerant vapor circulating through condenser 5 and discharged as heat conditioned air 21 into the enclosed space. Efficiency is therefore further increased by positioning the subcooler condenser, fan, and compressor inside air handler enclosure 15 upstream from condenser coil 5 of the primary refrigeration circuit so that pre-conditioned air 18 reaches the subcooler components first before it reaches condenser coil 5.

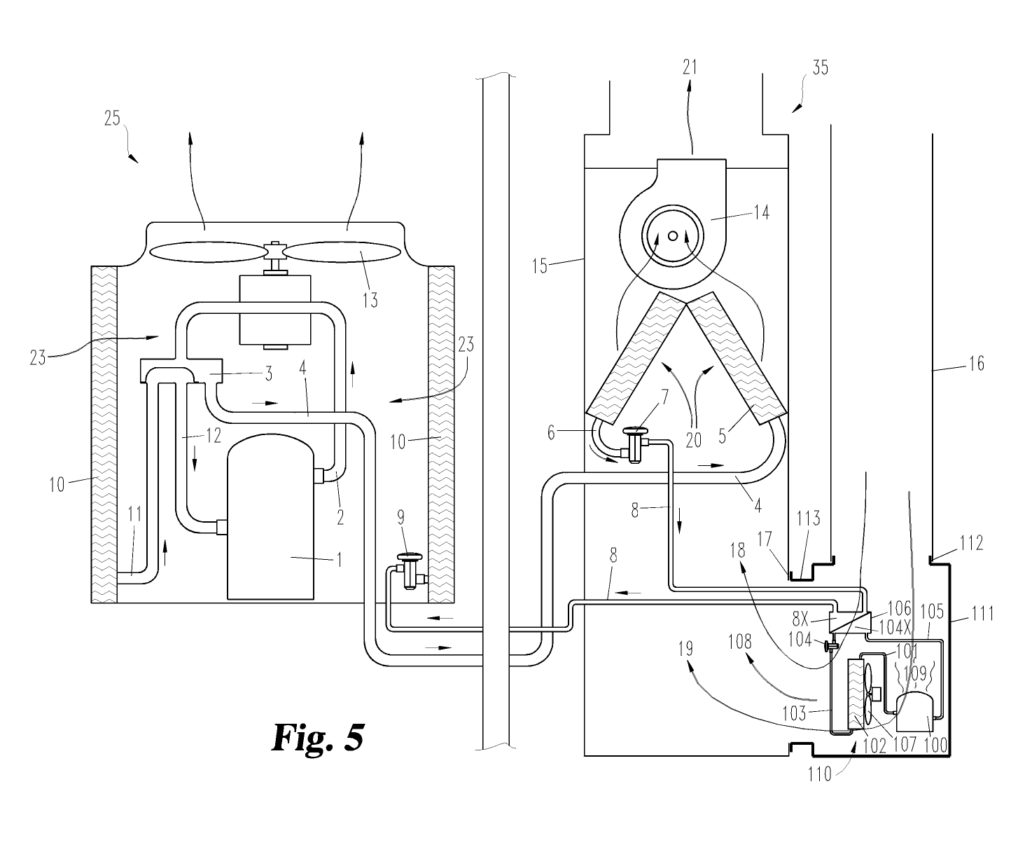

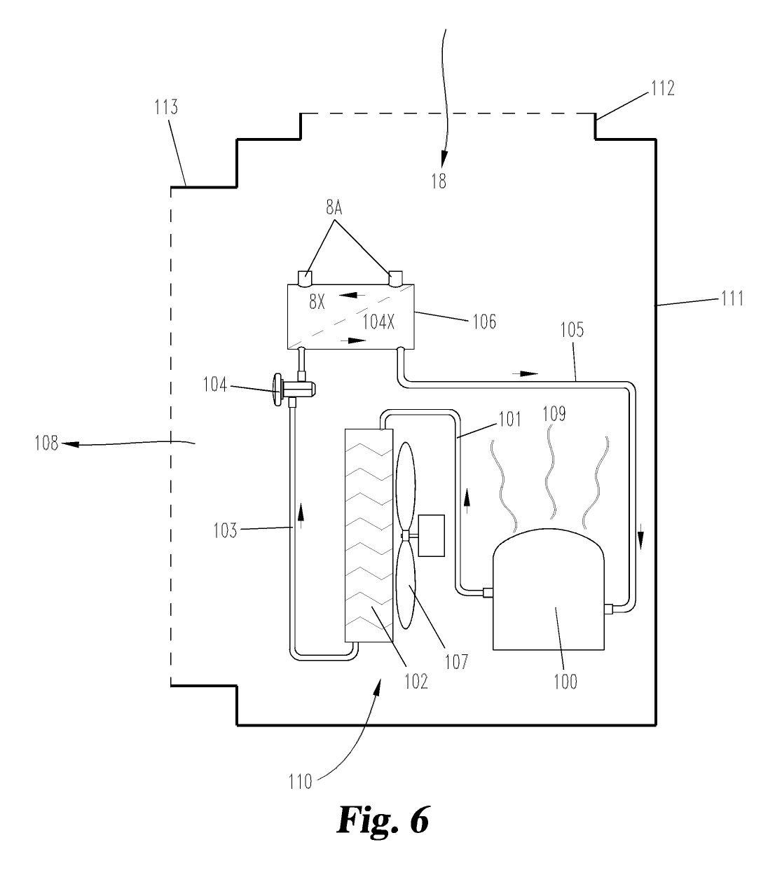

FIG. 5 illustrates another embodiment of an independent subcooler, which is also positioned upstream from the primary circuit condenser as in FIG. 4 except that the subcooling circuit 110 is housed in a separate enclosure 111 which is a separate duct section rather than a duct formed by air handler enclosure 15. Enclosure 111 is further adapted with inlet 112 and outlet 113, wherein Inlet 112 is adapted to interface enclosure 111 with the systems return air duct 16, and outlet 113 is adapted to interface enclosure 111 with air handler enclosure 15 at return air inlet 17. Heat exchanger 106 is adapted to receive conduit 8 at flow connections 8A (refer to FIG. 6) of heat exchanger 106, wherein connections are made at time of installation. This arrangement provides a means by which prior art heat pumps can be readily adapted with the subcooling function of the present invention to achieve all the benefits thereof.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by the following claims are desired to be protected.

What is claimed is:

1. A heat pump system having both a heating and a cooling mode comprising:
A primary condenser, a primary evaporator, a primary expansion device, and a primary compressor coupled together to form a primary closed refrigeration circuit for circulating a primary refrigerant, the primary closed refrigeration circuit operating in the heating mode to heat an enclosed space;
A secondary condenser, a secondary evaporator, a secondary expansion device, and a secondary compressor, coupled together to form a secondary closed refrigeration circuit for circulating a secondary refrigerant;
The secondary evaporator being coupled to the primary refrigeration circuit to cool the primary refrigerant before the primary refrigerant enters the primary evaporator, and;
The secondary closed refrigeration circuit being positioned to dissipate heat into the enclosed space.

2. A heat pump system having both a heating and a cooling mode comprising:
A primary condenser, a primary evaporator, a primary expansion device, and a primary compressor coupled together to form a primary closed refrigeration circuit containing a primary refrigerant where the primary condenser is positioned inside an enclosed space and the primary evaporator is positioned outside the enclosed space;
A secondary condenser, a secondary evaporator, a secondary expansion device, and a secondary compressor, coupled together to form a secondary closed refrigeration circuit containing a secondary refrigerant;
Wherein the secondary evaporator has a primary refrigerant path through the secondary evaporator that is coupled to the primary closed refrigerant circuit, and a separate secondary refrigerant path through the secondary evaporator coupled to the secondary closed refrigeration circuit, and;
Wherein the secondary closed refrigeration circuit is positioned upstream from the primary condenser.

3. The heat pump system of claim 1 or 2 where the secondary evaporator is a heat exchanger having separate fluid flow paths for the primary refrigerant and the secondary refrigerant.

4. The heat pump system of claim 3 where the heat exchanger is a plate type heat exchanger.

5. The heat pump system of claim 3 where the heat exchanger is a tube-in-tube type heat exchanger.

6. A method of retrofitting an existing heat pump system operating in the heating mode to more efficiently heat an enclosed space, the heat pump system having a primary condenser, a primary evaporator, a primary expansion device, and a primary compressor coupled together to form a primary closed refrigeration circuit for circulating a primary refrigerant, comprising:
Obtaining a secondary heat pump system having a secondary condenser, a secondary evaporator, a secondary expansion device, and a secondary compressor, coupled together to form a secondary closed refrigeration circuit for circulating a secondary refrigerant;
Coupling the secondary evaporator to the primary refrigeration circuit to cool the primary refrigerant before it enters the primary evaporator;
Placing the secondary closed refrigeration circuit inside the enclosed space so that heat generated by the secondary heat pump system heats the enclosed space.

7. The heat pump system of claim 1, 2, or 6 where the primary refrigerant and the secondary refrigerant are different refrigerants.

8. The heat pump system of claim 7 where the primary refrigerant has a pressure of between about 50 psig and about 105 psig at 0 degrees Centigrade.

9. The heat pump system of claim 8 where the primary refrigerant is R-22.

10. The heat pump system of claim 8 where the primary refrigerant is R-410A.

11. The heat pump system of claim 7 where the secondary refrigerant has a pressure of about 25 psig at 0 degrees Centigrade.

12. The heat pump system of claim 11 where the secondary refrigerant is R-134A.

13. The heat pump system of claim 1, 2, or 6 where the secondary condenser is positioned inside a duct ahead of the primary condenser in the flow of air moving through the duct.

14. The heat pump system of claim 1, 2, or 6 where the secondary refrigeration circuit is positioned inside a duct upstream from the primary condenser.
